(19) United States
(12) Patent Application Publication
(10) Pub. No.: US 2022/0337807 A1
(43) Pub. Date: Oct. 20, 2022

(54) CROSSTALK COMPENSATION FOR 3D LIGHTFIELD DISPLAYS

(71) Applicant: Google LLC, Mountain View, CA (US)

(72) Inventor: John D. Perreault, Mountain View, CA (US)

(21) Appl. No.: 17/596,783

(22) PCT Filed: Apr. 15, 2021
(86) PCT No.: PCT/US2021/070394

§ 371 Date: Dec. 17, 2021

(51) Int. Cl. H04N 13/398; H04N 13/305; H04N 17/00; H04N 13/383; H04N 13/125

(52) U.S. Cl. CPC H04N 13/398; H04N 13/305; H04N 17/00; H04N 13/383; H04N 13/125

(57) ABSTRACT

Techniques of crosstalk compensation include performing a crosstalk measurement operation on each of a plurality of cells of a display to produce a plurality of crosstalk measurement, and then in response to detecting an observer in a field of view (FOV) of the display, performing a crosstalk compensation operation on each of the plurality of cells to reduce crosstalk to below a perceptual threshold of the observer. Each cell produces luminance over a series of repeat zones, with each repeat zone being a left or right channel and the repeat zones alternating these channels. A computer may measure the crosstalk by analyzing the values of the luminance over phase within each repeat zone. In some implementations, each cell is associated with a lookup table of crosstalk values. When an observer is detected in the FOV of the display, the computer performs a crosstalk compensation operation using the measured luminance values.

### TECHNICAL FIELD

This description relates to crosstalk compensation for three-dimensional lightfield displays.

### BACKGROUND

Stereoscopic three-dimensional (3D) displays present a 3D image to an observer by sending a slightly different perspective view to each of an observer's two eyes, to provide an immersive experience to the observer. The visual system of an observer may process the two perspective images so as to interpret an image containing a perception of depth by invoking binocular stereopsis so the observer can see the image in 3D. Some stereoscopic displays send stereo images to each of a left eye and a right eye of an observer over left and right channels, respectively.

3D lightfield displays are stereoscopic displays that produce an autostereoscopic effect that enables an observer to perceive stereoscopic images without the use of special headgear worn by the observer. An example 3D lightfield display uses lenticular optics to provide the autostereoscopic effect. The lenticular optics may be formed as a series of vertically-oriented cylindrical lenses formed on a sheet that is fitted onto a display screen.

### SUMMARY

In one general aspect, a method can include performing, on a display having a plurality of cells, each of the plurality of cells producing a luminance in a left channel and a right channel directed toward a left eye and a right eye, respectively, of an observer, a crosstalk measurement operation on each of the plurality of cells of the display to produce a plurality of crosstalk measurements, each of the plurality of crosstalk measurements representing a fraction of luminance from a first channel that is measured in a second channel, the first channel being one of the left channel and the right channel, the second channel being the other of the left channel and the right channel. The method can also include, in response to detecting the observer within a field of view (FOV) of the display, performing a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.

In another general aspect, a computer program product comprising a nontransitive storage medium, the computer program product including code that, when executed by processing circuitry of a computing device, causes the processing circuitry to perform a method. The method can include, in response to detecting the observer within a field of view (FOV) of the display, performing a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.

In another general aspect, an electronic apparatus comprises memory and controlling circuitry coupled to the memory. The controlling circuitry can be configured to perform, on a display having a plurality of cells, each of the plurality of cells producing a luminance in a left channel and a right channel directed toward a left eye and a right eye, respectively, of an observer, a crosstalk measurement operation on each of the plurality of cells of the display to produce a plurality of crosstalk measurements, each of the plurality of crosstalk measurements representing a fraction of luminance from a first channel that is present in a second channel, the first channel being one of the left channel and the right channel, the second channel being the other of the left channel and the right channel. The controlling circuitry can also be configured to, in response to detecting the observer within a field of view (FOV) of the display, perform a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example 3D lightfield display.

FIG. 1B is a diagram that illustrates an example electronic environment for implementing the technical solution described herein.

FIG. 2A is a diagram that illustrates an example set of repeat zones of a cell of a lenticular display.

FIG. 2B is a diagram that illustrates an example luminance measurement on a set of repeat zones of a cell of a lenticular display.

FIG. 3A is a diagram that illustrates an example phase-shifted grating test pattern with varying rephased fractions and their luminance over a repeat zone.

FIG. 3B is a diagram that illustrates an example set of luminance vs. phase plots for a repeat zone in different cells of a display.

FIG. 4 is a flow chart that illustrates an example method of performing the improved techniques within the electronic environment illustrated in FIG. 1B.

FIG. 5 illustrates an example of a computer device and a mobile computer device that can be used with circuits described here.

### DETAILED DESCRIPTION

A technical problem with conventional 3D lightfield displays concerns crosstalk, or leakage, between left and right channels. Crosstalk is defined as an amount of light in a first channel (e.g., left) that leaks into a second (e.g., right) channel. Crosstalk in such displays may lead to ghosting and loss of contrast, loss of 3D effect and depth resolution, viewer discomfort, reduced limits of fusion, reduced image quality and reduced visual comfort, and reduced perceived magnitude of depth.

In contrast to the 3D lightfield displays having the above-described technical problem, a technical solution to the above-described technical problem includes performing a crosstalk measurement operation on each of a plurality of cells of a display to produce a plurality of crosstalk measurement, and then, in response to detecting an observer in a field of view (FOV) of the display, performing a crosstalk compensation operation on each of the plurality of cells to reduce crosstalk below a perceptual threshold of the observer. For example, some lenticular displays have a plurality of cells, and in some implementations, the cells include pixels or groups of pixels. Each cell produces luminance over a series of repeat zones, with each repeat zone being a left or right channel and the repeat zones alternating these channels. Each repeat zone is defined by a single 360-degree cycle of phase in the field of view (FOV). A computer may measure the crosstalk by analyzing the values of the luminance over phase within each repeat zone. In some implementations, each cell is associated with a lookup table of crosstalk values. When an observer is detected in the FOV of the display, the computer performs a crosstalk compensation operation using the measured luminance values.

A technical advantage of the above-described technical solution is that the technical solution avoids the perception of crosstalk and accordingly provides an improved immersive experience for an observer.

In some implementations, the display is an autostereoscopic display having lenticular optical elements that define a plurality of repeat zones, each of the plurality of repeat zones corresponding to a respective phase cycle of luminance at the observer. In some implementations, performing the crosstalk measurement operation on each of the plurality of cells of the display can include measuring luminance values over each repeat zone corresponding to that cell of the display, determining crosstalk measurement values over each repeat zone based on the measured luminance values, and storing the crosstalk measurement values in a lookup table (LUT) for that cell of the display.

In some implementations, determining the crosstalk measurement values over each repeat zone can include generating, for a repeat zone, a contrast of the luminance values over the repeat zone, the crosstalk measurement value for the repeat zone varying inversely with the contrast.

In some implementations, generating the contrast of the luminance values over the repeat zone can include performing an interpolation operation on the luminance values to produce a continuous curve of luminance over the repeat zone, the contrast of the luminance values being based on values of the luminance on the continuous curve.

In some implementations, performing the crosstalk compensation operation on a cell of the plurality of cells can include obtaining the LUT for that cell, and then, for each of the repeat zones of the cell, generating a compensation factor based on the crosstalk measurement value for that repeat zone, and then applying the compensation factor to measured luminance values in left and right channels within that repeat zone.

In some implementations, generating the compensation factor can include forming an inverse of a matrix, the matrix having ones as diagonal elements and the compensation factor as off-diagonal elements, and multiplying a vector having the measured luminance values in left and right channels as elements of the vector by the inverse of the matrix.

In some implementations, measuring luminance values over each repeat zone can include rendering at least one test pattern on the display, with the at least one test pattern producing the luminance values for measurement.

In some implementations, the at least one test pattern can include a series of alternating bright field and dark field lines. In some implementations, the at least one test pattern can include a series of alternating phase-shifted lines. In some implementations, the at least one test pattern can include a checkerboard pattern.

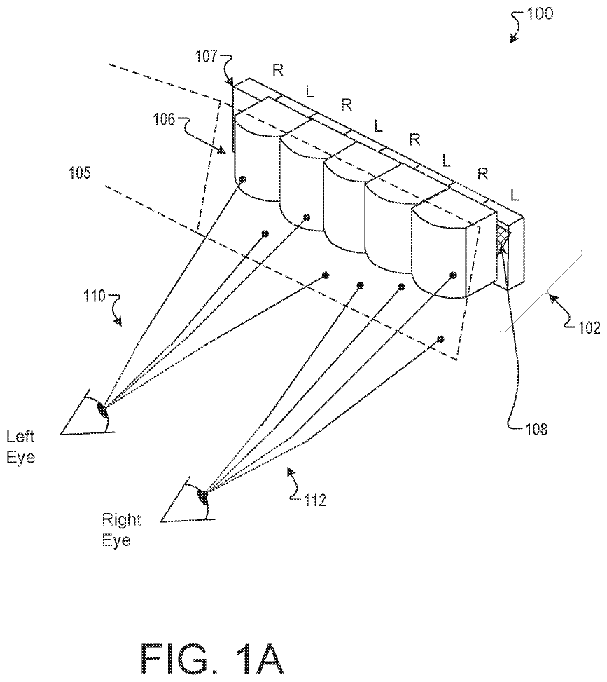

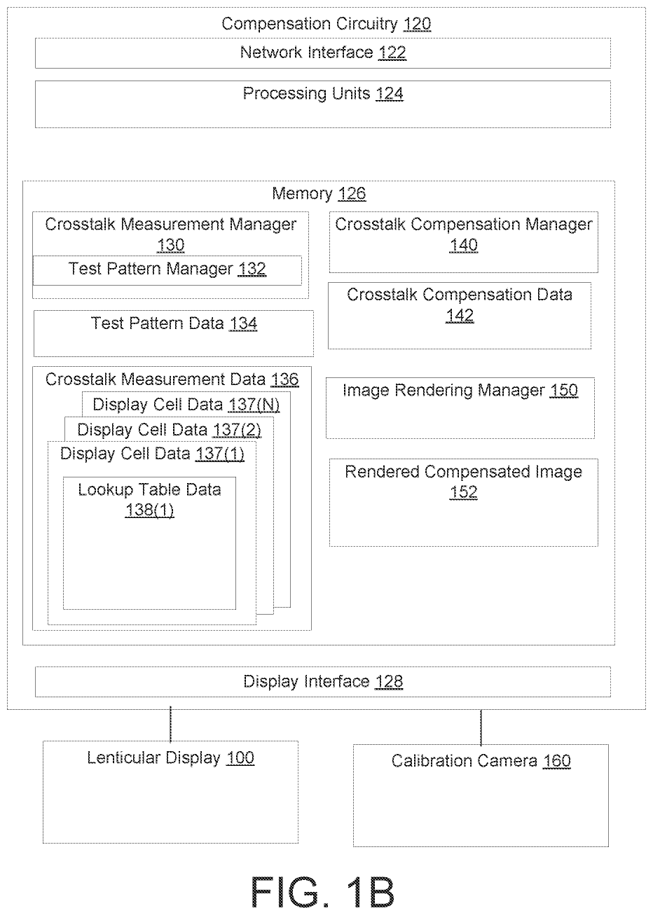

FIG. 1A is a diagram that illustrates an example 3D lightfield display 100. Specifically, display 100 is a lenticular display.

The 3D lightfield display assembly 102 shown in FIG. 1 represents an assembled display that includes at least a high-resolution display panel 107 coupled to (e.g., bonded to) a lenticular array of lenses 106. In addition, the assembly 102 may include one or more glass spacers 108 seated between the lenticular array of lenses and the high-resolution display panel 107. The array of lenses 106 (e.g., the microlens array) and glass spacers 108 may be designed such that, during operation of the display assembly 102, at a particular viewing condition, the left eye of the user views a first subset of pixels associated with an image, as shown by viewing rays 110, while the right eye of the user views a mutually exclusive second subset of pixels, as shown by viewing rays 112.

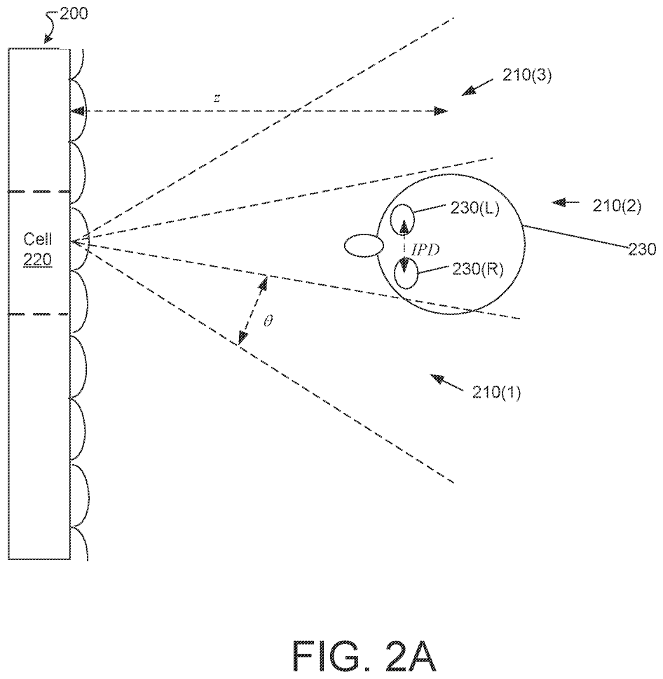

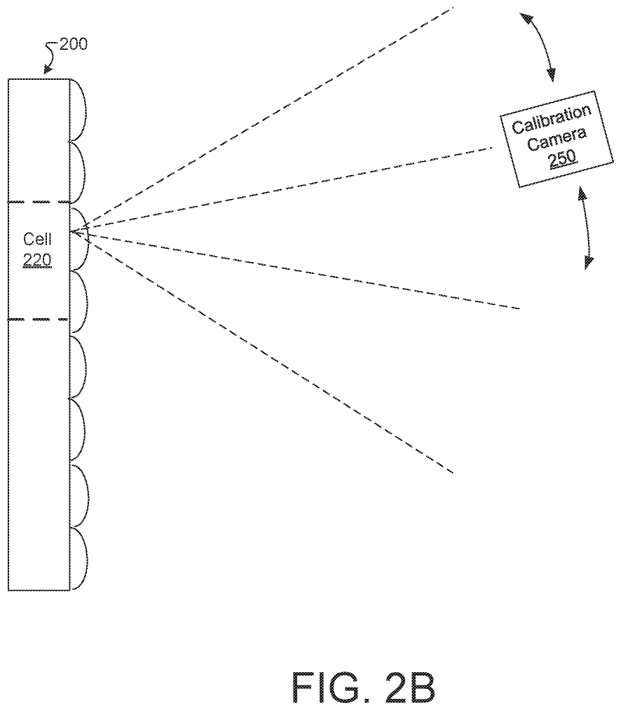

In some implementations, at least one of the first subset of pixels and at least one of the second subset of pixels forms a cell of the display. As is shown with regard to FIG. 2, each cell produces luminance in alternating left and right channels for each single-phase-cycle, and such cycles are contained in repeat zones. That is, a cell encompasses a number of repeat zones. Within a repeat zone for a first channel (left or right), there may be crosstalk from the other channel.

FIG. 1B is a diagram that illustrates an example electronic environment in which the above-described improved techniques may be implemented. As shown in FIG. 1B, the example electronic environment includes compensation circuitry 120, the 3D lightfield display 100, and a calibration camera 160.

The compensation circuitry 120 includes a network interface 122, one or more processing units 124, memory 126, and a display interface 128. The network interface 122 includes, for example, Ethernet adaptors, and the like, for converting electronic and/or optical signals received from a network to electronic form for use by the computer 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein. The display interface 128 includes adaptors for interfacing with the 3D lightfield display 100.

In some embodiments, one or more of the components of the compensation circuitry 120 can include processors (e.g., processing units 124) configured to process instructions stored in the memory 126. Examples of such instructions as depicted in FIG. 1B include a crosstalk measurement manager 130, a crosstalk compensation manager 140, and an image rendering manager 150. Further, as illustrated in FIG. 1, the memory 126 is configured to store various data, which is described with respect to the respective managers that use such data.

The crosstalk measurement manager 130 is configured to cause the compensation circuitry 120 to obtain crosstalk measurement data 136 at each cell of the display 100, where the measurement data is to be used in compensation operations. In some implementations, the crosstalk measurement manager 130 causes the compensation circuitry 120 to obtain the crosstalk measurement data 136 over the network interface 122, i.e., over a network. In some implementations, the crosstalk measurement manager 130 causes the compensation circuitry 120 to obtain the crosstalk measurement data 136 over the display interface 128.

In some implementations, the crosstalk measurement manager 130 causes the compensation circuitry 120 to obtain crosstalk measurements within the FOV of the display 100 by displaying test patterns on the display 100 and recording measured luminance within each repeat zone within the cells of the display 100 as the test patterns are displayed. As shown in FIG. 1B, the crosstalk measurement manager 130 includes a test pattern manager 132.

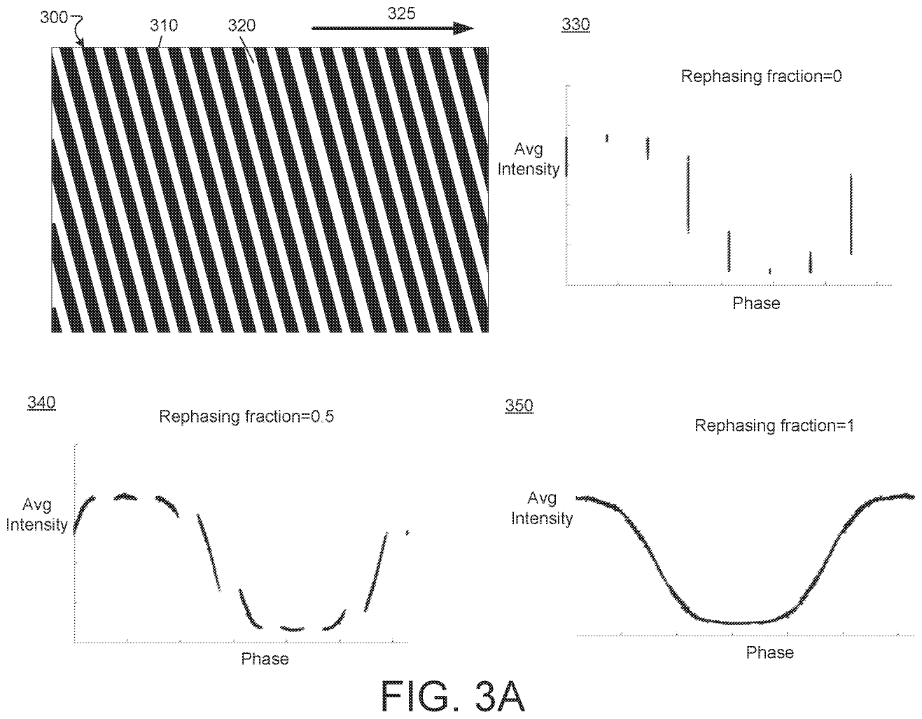

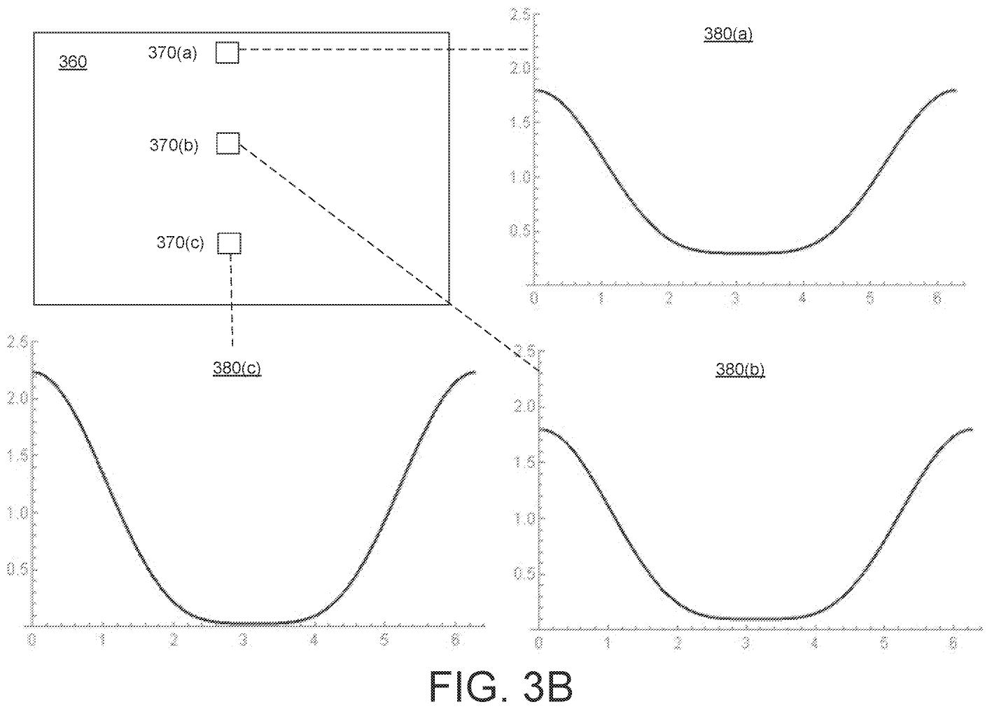

Test pattern manager 132 is configured to obtain for display 100 test pattern data 134 used in performing crosstalk measurements. In some implementations, the test pattern manager 132 is configured to generate test pattern data 134 for the crosstalk measurements. In some implementations, the test pattern manager 132 is configured to retrieve test pattern data 134 from local or remote storage. In some implementations, test pattern manager 132 is configured to arrange test pattern data 134 in a sequence for performing various measurements. For example, in some implementations, display crosstalk may be measured using a series of phase shifting lines of specified pitches. In some implementations, the phase shifting lines may be included in a Moiré pattern or a diffraction grating pattern. In some implementations, the phase shifting lines of the pattern are bright-field lines interspersed with dark field lines to remove non-uniformities in the display. the pitch of the pattern may be defined as the sum of widths of neighboring bright and dark lines when the bright and dark lines form a repeating pattern. In some implementations, the test pattern data 134 includes a checkerboard pattern. Examples of crosstalk measurements are shown with regard to FIGS. 3A and 3B.

In some implementations, the crosstalk measurements are performed in the FOV with the calibration camera 160. The camera 160 may be positioned to measure luminance of a cell within a single repeat zone or over several repeat zones. The camera 160 may be moved from cell to cell, or the camera 160 may be angled to capture light emitted from various cells of the display. The calibration camera 160 may be connected to the compensation circuitry 120 over a wireless or wired connection via the network interface 122 or the display interface 128.

In some implementations, crosstalk is defined as a fraction of the luminance or light energy in a first channel that is intended for a second channel. That is, crosstalk is the incomplete isolation of the left and right image channels so that the content from one channel is measured in another channel.

In some implementations, the crosstalk may be determined based on a relationship between the luminance (luminant intensity) of light and the phase over a repeat zone. Such a relationship, examples of which may be seen in FIGS. 3A and 3B, may have a maximum luminance and a minimum luminance over the repeat zone. The crosstalk within the repeat zone may then be defined based on the contrast of the luminance over phase within the repeat zone. In some implementations, the crosstalk is defined as the contrast within the repeat zone. That is, when the minimum luminance over the repeat zone is much smaller than the maximum luminance within the repeat zone, the crosstalk is small. When the minimum luminance over the repeat zone is not small relative to the maximum luminance within the repeat zone, the crosstalk is large.

The crosstalk measurement data 136 represents the crosstalk measurements within each repeat zone of each cell of the display 100. As shown in FIG. 1B, the crosstalk measurement data 136 includes display cell data 137(1), 137(2), . . . , 137(N), for each cell of the display 100. (It is assumed there are N cells in the display.) In some implementations, data for each display cell data includes a display cell identifier identifying that cell. In some implementations, the display cell identifier is a numeral corresponding to the cell, e.g., “1” for display cell data 137(1).

Data for each display cell includes lookup table data. For example, display cell data 137(1) includes corresponding lookup table data 138(1), display cell data 137(2) includes corresponding lookup table data 138(2), and so on. The lookup table data 137(1) represents a crosstalk measurement value within each repeat zone of that cell. In some implementations, the lookup table data 138(1) takes the form of a table having columns including a repeat zone identifier and a crosstalk measurement value. In some implementations, the table also has a column including an observer position within the FOV. In some implementations, the table also has a column including a gaze direction of an observer within the FOV In some implementations, there are different LUTs for different viewing states, i.e., observer position and gaze direction, for a cell. In such implementations, the compensation circuitry 120 would then retrieve the LUT corresponding to a particular viewing state.

The crosstalk compensation manager 140 is configured to perform crosstalk compensation operations in real time using the crosstalk measurement data 136, specifically the lookup table data 138(1), . . . , 138(N), in response to detecting an observer within the FOV of the display 100, to produce crosstalk compensation data 142. In some implementations, each repeat zone represented in each lookup table, i.e., lookup table data 138(1), includes a single crosstalk value X.

Nevertheless, each repeat zone also represents a left channel or a right channel. Accordingly, a crosstalk measurement value X_{L} within a repeat zone for a left channel may represent the amount of light from the right channel measured in the left channel. A crosstalk measurement value X_{R} within a repeat zone for a right channel may represent the amount of light from the left channel measured in the right channel.

In some implementations, adjacent repeat zones for left channels and right channels may be compensated together by crosstalk compensation manager 140 using a matrix formulation as follows. Consider left and right luminances L and R generated at the display. With crosstalk present in each channel, the observed luminances may take the following form:

L_{obs}=L+X_{L}R,

R_{obs}=R+X_{R}L,

or, in matrix form,

$$( \begin{matrix}{L}_{obs} \\ {R}_{obs}\end{matrix} ) = ( \begin{matrix}1 & {X}_{L} \\ {X}_{R} & 1\end{matrix} ) ( \begin{matrix}L \\ R\end{matrix} ) .$$

Accordingly, to determine the compensated luminances for the left and right channels, respectively, one left-multiplies by the inverse of the above matrix as follows:

$$( \begin{matrix}L \\ R\end{matrix} ) = \frac{1}{1 - {X}_{L} {X}_{R}} ( \begin{matrix}1 & - {X}_{R} \\ - {X}_{L} & 1\end{matrix} ) ( \begin{matrix}{L}_{obs} \\ {R}_{obs}\end{matrix} ) .$$

That is, execution of the instructions of the crosstalk compensation manager 140 causes a compensation operation to be performed by multiplying the measured luminances in the left and right channels by the above inverse matrix. In some implementations, the crosstalk compensation data 142 represents the compensated luminance within each repeat zone for each cell of the display 100.

In some implementations, the left and right crosstalk measurements are assumed to be equal. This assumption cuts in half the number of measurements and crosstalk compensation operations that need to be performed. In this case, the crosstalk compensation manager 140 uses a value X=X_{L}=X_{R} in the above matrix equation to determine the actual luminance values from the observed luminance values within each repeat zone.

The image rendering manager 150 is configured to render compensated image content, i.e., rendered compensated image 152, onto the display 100 for viewing by an observer. In some implementations, the image rendering manager 150 is also configured to render sequences of test patterns, i.e., test pattern data 134, onto the display for calibration and/or crosstalk measurement by the calibration camera 160.

FIG. 2A is a diagram that illustrates a top view of an example set of repeat zones 210(1L), . . . , 210(3R) of a cell 220 of a lenticular display 200.

A repeat zone, e.g., repeat zone 210(1L) is defined by the optics of the lenticular display and is accordingly fixed in size for a given display. For example, the angular extent θ of a repeat zone may be determined from the formula θ=2 IPD/z, where IPD is an expected interpupil distance of an observer 230, i.e., the center-to-center distance between pupils of the left eye 230(L) and right eye 230(R), and z is the distance between the observer 230 and a rear surface of the display 200. The angular extent θ may also be determined from the formula θ=p/f, where p is a width of a lenticular element and f is a distance between the front screen of the display 200 and the rear surface of the display 200. In some implementations, the computer may steer an orientation of a repeat zone to track the observer's 230 head movement/gaze angle, e.g., with respect to a normal of the front screen of the display 200.

It is noted that the angular extent θ of a repeat zone, e.g., repeat zone 210(1L), is not the same as a phase over which the luminance within a repeat zone is measured. The angular extent θ of a repeat zone defines a position of the repeat zone within the FOV. The phase over which the luminance within a repeat zone is measured, in contrast, is taken with respect to a period of a test pattern used for the crosstalk measurement operation

FIG. 2B is a diagram that illustrates an example luminance measurement on the set of repeat zones of the cell of the lenticular display. As shown in FIG. 2B and as discussed with regard to FIG. 1B, the measurement of the luminance over the repeat zones is accomplished using a calibration camera 250. By using the reference checkerboard test pattern, the crosstalk measurement manager 130 obtains a position and orientation (viewpoint) of the calibration camera 250. In some implementations, the crosstalk measurement manager 130 uses computer vision techniques in obtaining position and orientation. That is, for each viewpoint there is a checkerboard pattern defining that viewpoint. The crosstalk measurement manager 130 then uses phase-shifted lines to define the crosstalk for a viewpoint.

The crosstalk is measured within each repeat zone using any of a series of phase-shifting Moiré or diffraction grating test patterns. The luminance due to these patterns is illustrated in FIGS. 3A and 3B.

FIG. 3A is a diagram that illustrates an example phase-shifting grating test pattern 300 with varying rephased fractions and their luminances over a repeat zone within a cell of a display. As shown in FIG. 3A, the test pattern 300 includes a set of dark-field lines 310 and bright-field lines 320. In the test pattern 300, the lines 310 and 320 are tilted at an angle. As shown in FIG. 3A, the phase-shifting pattern 300 changes its phase via a horizontal motion 325 across the display. The result of this motion 325 is a beat pattern between the lenticular display and phase-shifted pattern 300. Also as shown in FIG. 3A, the lines of the phase-shifting pattern 300 are tilted with respect to the vertical. Such tilts in the lines may be useful because the display may not be aligned with the phase-shifted pattern 300 due to fabrication factors. In some implementations, the test pattern 300 may simply have bright-field lines that are alternatively phase-shifted, e.g., every other line has a phase shift of 180 degrees. Nevertheless, it has been observed that the presence of alternate dark and bright field lines, e.g., lines 310 and 320, may remove non-uniformities in the display, e.g., display 100 and calibration camera 160. Such nonuniformities include, for example, nonuniformities in pixel brightness due to imperfections in the manufacture of the lenticular optics. Such a nonuniformity may be realized in the test pattern being brighter in the center than on the edges of the screen. In this way, the phase-shifting pattern 200 reduces sensitivity to systematic error sources.

In some implementations, the test pattern 300 may take the form of a checkerboard pattern, i.e., alternating dark-field and bright-field rectangles replacing dark-field and bright-field lines 310 and 320. A benefit of using a checkerboard pattern is that the crosstalk measurement manager 130 (FIG. 1B) may determine camera pose using, e.g., computer vision techniques and, accordingly, observer gaze direction with that pattern.

The varying phases of the test pattern 300, as shown in FIG. 3A, give rise to different plots 330, 340, 350, of luminance vs. phase over a repeat zone, i.e., a complete phase cycle of 360 degrees, or 2π radians. For example, the plot 330 results from the test pattern 300 using a rephased fraction (i.e., shift representing a fraction of a complete phase cycle) of 0.0. Note that, for such a low value of the rephasing fraction, the plot of luminance over phase is sparsely sampled. For larger values of the rephasing fraction −0.5 for plot 340 and 1.0 for plot 350—results in smaller breaks in the luminance curve within a repeat zone.

The crosstalk measurement values are derived from these curves based on the contrast; that is, a ratio of the minimum luminance to the maximum luminance over the repeat zone. In some implementations, the contrast may be defined as a ratio of a difference between maximum and minimum luminance and a sum of maximum and minimum luminance.

In cases where the luminance curves are not fully continuous, in some implementations the crosstalk measurement manager 130 performs an interpolation operation on the luminance curves to produce a continuous luminance curve from which an accurate contrast and accordingly a crosstalk value may be derived. In some implementations, the interpolation used is a cubic spline curve with continuous derivatives. In some implementations, the interpolation used is a linear interpolation.

The plots 330, 340, and 350 shown in FIG. 3A were generated for a single cell of the display. Nevertheless, it is clear that such plots of luminance vs. phase may vary with the location of cells in the display. To this effect, FIG. 3B shows a display 360 with different cells 370(a), 370(b), and 370(c). Each of these cells produces a plot of luminance vs. phase for repeat zones in similar positions, i.e., angular ranges within the FOV. That is, plot 380(a) corresponds to cell 370(a), plot 380(b) corresponds to cell 370(b), and plot 380(c) corresponds to cell 370(c). These plots 380(a,b,c) show different values of contrast and hence different crosstalk measurement values. Note also these plots 380(a,b,c) are fully continuous because the discontinuous plots were fit using cubic splines.

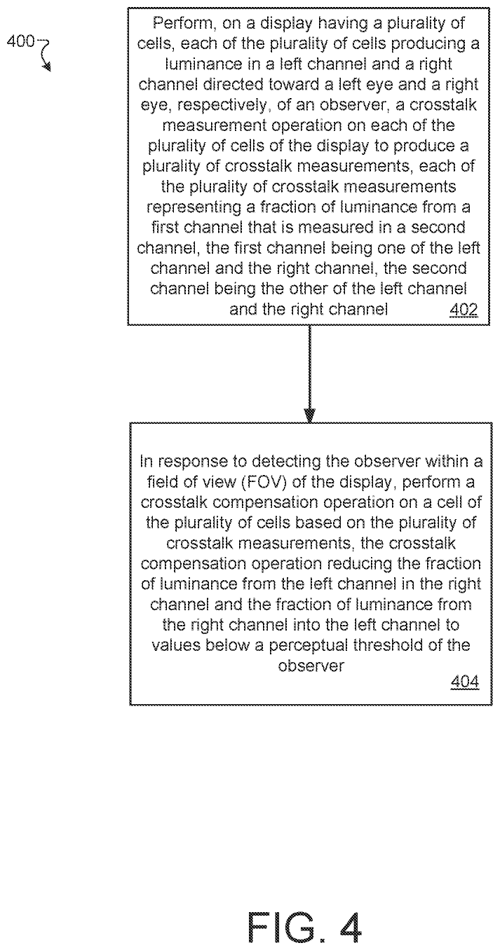

FIG. 4 is a flow chart depicting an example method 400 of solving the above-described technical problem. The method 400 may be performed by software constructs described in connection with FIG. 1B, which reside in memory 126 of the compensation circuitry 120 and are run by the set of processing units 124 or may be performed by software constructs that reside in memory of a computing device different from (e.g., remote from) compensation circuitry 120.

At 402, the crosstalk measurement manager 130 performs a crosstalk measurement operation on a display (e.g., display 360) that includes a plurality of cells (e.g., cells 370(a,b,c)), where each cell produces a luminance in a left channel and a right channel directed toward a left eye and a right eye (230(L,R)), respectively, of an observer (e.g., observer 230). The crosstalk measurement operation is performed on each of the plurality of cells of the display to produce a plurality of crosstalk measurements (e.g., crosstalk measurement data 136), where each crosstalk measurements represents a fraction of luminance from a first channel that is measured in a second channel, where the first channel is one of the left channel and the right channel, the second channel being the other of the left channel and the right channel.

At 404, in response to detecting the observer within a field of view (FOV) of the display, the crosstalk compensation manager 140 performs a crosstalk compensation operation on a cell (e.g., cell 220) of the plurality of cells based on the plurality of crosstalk measurements. The crosstalk compensation operation reduces the crosstalk to values below a perceptual threshold of the observer.

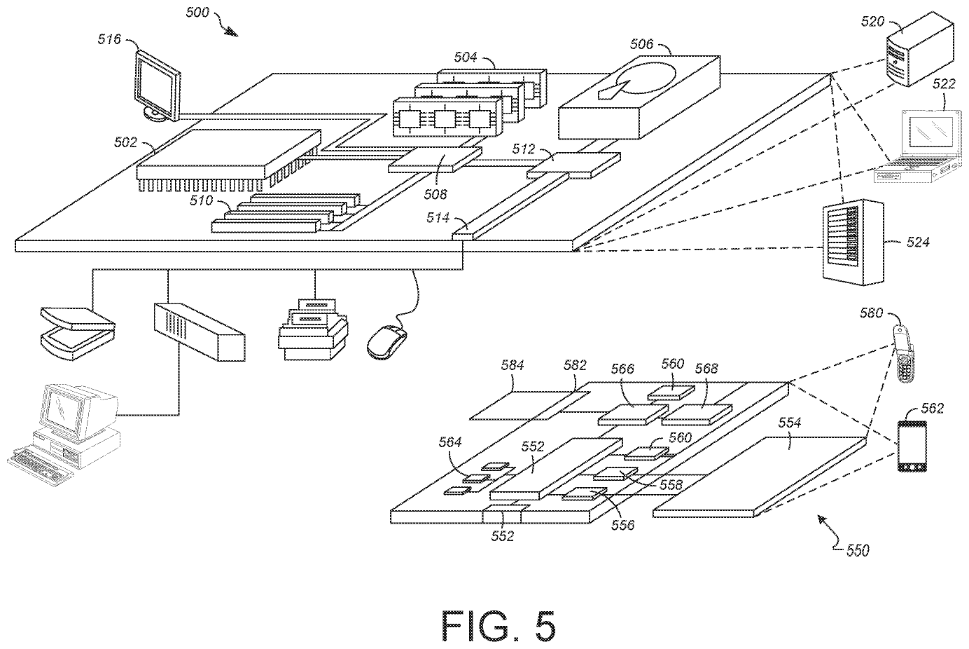

FIG. 5 illustrates an example of a generic computer device 500 and a generic mobile computer device 550, which may be used with the techniques described here.

As shown in FIG. 5, computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 450, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Returning to FIG. 1B, in some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the compensation circuitry 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the compression computer 120.

The components (e.g., modules, processing units 124) of the compensation circuitry 120 can be configured to operate based on one or more platforms (e.g., one or more similar or different platforms) that can include one or more types of hardware, software, firmware, operating systems, runtime libraries, and/or so forth. In some implementations, the components of the compensation circuitry 120 can be configured to operate within a cluster of devices (e.g., a server farm). In such an implementation, the functionality and processing of the components of the compensation circuitry 120 can be distributed to several devices of the cluster of devices.

The components of the compensation circuitry 120 can be, or can include, any type of hardware and/or software configured to process attributes. In some implementations, one or more portions of the components shown in the components of the compensation circuitry 120 in FIG. 1B can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the compensation circuitry 120 can be, or can include, a software module configured for execution by at least one processor (not shown). In some implementations, the functionality of the components can be included in different modules and/or different components than those shown in FIG. 1B.

Although not shown, in some implementations, the components of the compensation circuitry 120 (or portions thereof) can be configured to operate within, for example, a data center (e.g., a cloud computing environment), a computer system, one or more server/host devices, and/or so forth. In some implementations, the components of the compensation circuitry 120 (or portions thereof) can be configured to operate within a network. Thus, the components of the compensation circuitry 120 (or portions thereof) can be configured to function within various types of network environments that can include one or more devices and/or one or more server devices. For example, a network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some embodiments, one or more of the components of the compensation circuitry 120 can be, or can include, processors configured to process instructions stored in a memory. For example, the depth image manager 130 (and/or a portion thereof), the viewpoint manager 140 (and/or a portion thereof), the ray casting manager 150 (and/or a portion thereof), the SDV manager 160 (and/or a portion thereof), the aggregation manager 170 (and/or a portion thereof), the root-finding manager 180 (and/or a portion thereof), and the depth image generation manager 190 (and/or a portion thereof) can be a combination of a processor and a memory configured to execute instructions related to a process to implement one or more functions.

A number of embodiments have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
performing, on a display having a plurality of cells, each of the plurality of cells producing a luminance in a left channel and a right channel directed toward a left eye and a right eye, respectively, of an observer, a crosstalk measurement operation on each of the plurality of cells of the display to produce a plurality of crosstalk measurements, each of the plurality of crosstalk measurements representing a fraction of luminance from a first channel that is measured in a second channel, the first channel being one of the left channel and the right channel, the second channel being the other of the left channel and the right channel;
in response to detecting the observer within a field of view (FOV) of the display, performing a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.

2. The method as in claim 1, wherein the display includes an autostereoscopic display having lenticular optical elements that define a plurality of repeat zones, each of the plurality of repeat zones corresponding to a respective phase cycle of luminance at the observer; and
wherein performing the crosstalk measurement operation on each of the plurality of cells of the display includes:
measuring luminance values over each repeat zone corresponding to that cell of the display;
determining crosstalk measurement values over each repeat zone based on the measured luminance values; and
storing the crosstalk measurement values in a lookup table (LUT) for that cell of the display.

3. The method as in claim 2, wherein determining the crosstalk measurement values over each repeat zone includes:
generating, for a repeat zone, a contrast of the luminance values over the repeat zone, the crosstalk measurement value for the repeat zone varying inversely with the contrast.

4. The method as in claim 3, wherein generating the contrast of the luminance values over the repeat zone includes:
performing an interpolation operation on the luminance values to produce a continuous curve of luminance over the repeat zone, the contrast of the luminance values being based on values of the luminance on the continuous curve.

5. The method as in claim 2, wherein performing the crosstalk compensation operation on a cell of the plurality of cells includes:
obtaining the LUT for that cell;
for each of the repeat zones of the cell, generating a compensation factor based on the crosstalk measurement value for that repeat zone; and
applying the compensation factor to measured luminance values in left and right channels within that repeat zone.

6. The method as in claim 5, wherein generating the compensation factor includes:
forming an inverse of a matrix, the matrix having ones as diagonal elements and the compensation factor as off-diagonal elements; and
multiplying a vector having the measured luminance values in left and right channels as elements of the vector by the inverse of the matrix.

7. The method as in claim 2, wherein measuring luminance values over each repeat zone includes:
rendering at least one test pattern on the display, the at least one test pattern producing the luminance values for measurement.

8. The method as in claim 7, wherein the at least one test pattern includes a series of alternating bright field and dark field lines.

9. The method as in claim 7, wherein the at least one test pattern includes a series of alternating phase-shifted lines.

10. The method as in claim 7, wherein the at least one test pattern includes a checkerboard pattern.

11. A computer program product comprising a nontransitive storage medium, the computer program product including code that, when executed by processing circuitry, causes the processing circuitry to perform a method, the method comprising:
performing, on a display having a plurality of cells, each of the plurality of cells producing a luminance in a left channel and a right channel directed toward a left eye and a right eye, respectively, of an observer, a crosstalk measurement operation on each of the plurality of cells of the display to produce a plurality of crosstalk measurements, each of the plurality of crosstalk measurements representing a fraction of luminance from a first channel that is measured in a second channel, the first channel being one of the left channel and the right channel, the second channel being the other of the left channel and the right channel;
in response to detecting the observer within a field of view (FOV) of the display, performing a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.

12. The computer program product as in claim 11, wherein the display is an autostereoscopic display having lenticular optical elements that define a plurality of repeat zones, each of the plurality of repeat zones corresponding to a respective phase cycle of luminance at the observer; and
wherein performing the crosstalk measurement operation on each of the plurality of cells of the display includes:
measuring luminance values over each repeat zone corresponding to that cell of the display;
determining crosstalk measurement values over each repeat zone based on the measured luminance values; and
storing the crosstalk measurement values in a lookup table (LUT) for that cell of the display.

13. The computer program product as in claim 12, wherein determining the crosstalk measurement values over each repeat zone includes:
generating, for a repeat zone, a contrast of the luminance values over the repeat zone, the crosstalk measurement value for the repeat zone varying inversely with the contrast.

14. The computer program product as in claim 13, wherein generating the contrast of the luminance values over the repeat zone includes:
performing an interpolation operation on the luminance values to produce a continuous curve of luminance over the repeat zone, the contrast of the luminance values being based on values of the luminance on the continuous curve.

15. The computer program product as in claim 12, wherein performing the crosstalk compensation operation on a cell of the plurality of cells includes:
obtaining the LUT for that cell;
for each of the repeat zones of the cell, generating a compensation factor based on the crosstalk measurement value for that repeat zone; and
applying the compensation factor to measured luminance values in left and right channels within that repeat zone.

16. The computer program product as in claim 15, wherein generating the compensation factor includes:
forming an inverse of a matrix, the matrix having ones as diagonal elements and the compensation factor as off-diagonal elements; and
multiplying a vector having the measured luminance values in left and right channels as elements of the vector by the inverse of the matrix.

17. The computer program product as in claim 12, wherein measuring luminance values over each repeat zone includes:
rendering at least one test pattern on the display, the at least one test pattern producing the luminance values for measurement.

18. The computer program product as in claim 17, wherein the at least one test pattern includes a series of alternating bright field and dark field lines.

19. The computer program product as in claim 17, wherein the at least one test pattern includes a series of alternating phase-shifted lines.

20. An electronic apparatus, the electronic apparatus comprising:
memory; and
controlling circuitry coupled to the memory, the controlling circuitry being configured to:
perform, on a display having a plurality of cells, each of the plurality of cells producing a luminance in a left channel and a right channel directed toward a left eye and a right eye, respectively, of an observer, a crosstalk measurement operation on each of the plurality of cells of the display to produce a plurality of crosstalk measurements, each of the plurality of crosstalk measurements representing a fraction of luminance from a first channel that is measured in a second channel, the first channel being one of the left channel and the right channel, the second channel being the other of the left channel and the right channel;
in response to detecting the observer within a field of view (FOV) of the display, perform a crosstalk compensation operation on a cell of the plurality of cells based on the plurality of crosstalk measurements, the crosstalk compensation operation reducing the fraction of luminance from the left channel in the right channel and the fraction of luminance from the right channel into the left channel to values below a perceptual threshold of the observer.
